(19) United States
(12) Patent Application Publication
(10) Pub. No.: US 2007/0281107 A1
(43) Pub. Date: Dec. 6, 2007

(54) PLASMA PROCESSING METHOD

(76) Inventor: Hideo Kitagawa, Tottori-shi (JP)

Correspondence Address: MORGAN & FINNEGAN, L.L.P., 3 WORLD FINANCIAL CENTER, NEW YORK, NY, 10281-2101, US

(21) Appl. No.: 11/755,233

(22) Filed: May 30, 2007

(30) Foreign Application Priority Data
May 30, 2006 (JP) 2006-149751

(51) Int. Cl. H05H 1/24

(52) U.S. Cl. 427/569

(57) ABSTRACT

A method for irradiating plasma of a material to a substrate and introducing the material into the substrate includes an irradiation step of irradiating the plasma to the substrate during an irradiation time period in which the material is not diffused in the substrate, and a non-irradiation step of stopping irradiation of the plasma to the substrate during a non-irradiation time period in which the plasma disappears, wherein the irradiation step and the non-irradiation step are repeated.

### BACKGROUND OF THE INVENTION

1. Field of the Invention

The present invention relates to a plasma processing method.

2. Description of the Related Art

Along with the recent LSI design rule miniaturization, use of a silicon oxynitride film having a thickness of 2 nm or smaller as a gate insulating film has begun. The silicon oxynitride film has a high relative dielectric constant, and has a leak current relief effect and a boron dispersion preventive effect from a gate electrode. The silicon oxynitride film is manufactured by introducing nitrogen using plasma (nitriding) after the silicon oxynitride film is formed.

One silicon-oxide-film nitriding method uses plasma at a electron temperature as low as 2 eV or below to nitride silicon oxide film having an initial film thickness of 2.0 nm or greater, and introduces nitrogen into the film at a high concentration and few damages. The plasma's electron temperature is important because of a relationship between the plasma's electron temperature and the ion energy incident upon the substrate.

From a microscopic view, nitriding of silicon oxide film is a reaction of a substitution of O with N in a Si—O—Si bond. Presumably, this reaction is principally induced by incident atomic nitrogen ions N⁺, since the binding energy for each Si—O is as high as 6.5 eV. Indeed, a molecule orbital calculation indicates that atomic nitrogen ions N⁺ induce a substitution reaction of oxygen with incident energy of about 5 eV or greater (which corresponds to about 1.2 eV when converted into the electron temperature). When ions are incident with higher energy, the excessive energy is converted into cutting of another bond in a crystal or the kinetic energy of displaced oxygen atoms. It is presumed that the incident ion energy (electron temperature) is preferably close to the ideal value (5 eV), and the plasma at a low electron temperature can well-nitride a thinner film.

However, it has been discovered that according to the silicon-oxide-film nitriding method using the plasma, an introducible nitrogen concentration has a peak value of several percentages for a silicon oxide film having a film thickness of 1.2 nm, and more introduced nitrogen increases an equivalent oxide thickness (“EOT”). It is thus difficult to obtain a large film quality improvement effect.

Prior art disclose a method that uses Kr or N₂ gas (Japanese Patent Laid-Open No. 2002-261091), a method that uses Ar, H₂, or N₂ gas (Japanese Patent Laid-Open No. 2002-208593), a method that uses pulse discharge plasma (Japanese Patent Laid-Open No. 2004-296603).

In general, a N₂ molecule has a high disconnection voltage, and the electron temperature is high. When the inert gas having a low disconnection voltage, such as Ar, Kr, and Xe, is mixed, the electron temperature can be lowered. It is reported that the electron temperature can be actually lowered down to about 1.0 eV.

A method that dilutes with a diluent gas is particularly effective to the oxidization using O₂/inert plasma. In the oxidization process, the reactive species is an oxygen atom, and an addition of inert gas converts the energy between the inert gas metastable state and an O₂ molecule, and the oxygen atom as the reactive species is efficiently generated. In the process that uses a mixture gas of N₂/inert gas, the disconnection voltage is so high that nitrogen atoms (N) and the nitrogen atom ions (N⁺) having high reactivity seldom occur, but a large amount of nitrogen molecule ions (N₂⁺) having low reactivity, nitrogen molecules in the exited state, and inert gas ions are generated.

Therefore, when a silicon oxide film is nitrided with the plasma, various problems occur: For example, a reaction that substitutes O with N in a Si—O—Si bond is unlikely to occur. The plasma is taken as N₂ in the film, and desorpted in the subsequent heat treatment.

An addition of H₂ to N₂/inert gas would result in a large amount of ammonia (NH₃) or ammonium ions (NH₄⁺). These active species has higher reactivity than N₂-based active species, and can introduce more nitrogen. In addition, a process in an atmosphere that contains a large amount of hydrogen terminates dangling bonds in the film with hydrogen, providing a silicon oxynitride film having an excellent initial characteristic. However, long-term use of this silicon oxynitride film results in gradual hydrogen desorption, and gradually deteriorates its characteristic.

When a silicon oxide film becomes about 1.2 nm thick, nitrogen atoms in the plasma and oxide species (oxygen atom and NO molecule) generated in the nitriding reaction easily diffuse in the silicon oxide film and reach the silicon substrate. Thereby, the silicon substrate is nitrided or oxidized, and a physical film thickness increases. Not only the incident ion energy of N⁺ ions as activated species but also a new nitriding method that takes care of diffusions in the nitride or oxide species in the film are necessary for a thin film having a film thickness of 1.2 nm or smaller.

Since the film becomes thicker due to oxidation or nitriding of the silicon substrate when a silicon oxide film having a film thickness of 1.2 nm or smaller is nitrided with the N₂ plasma, it is difficult to decrease the EOT. Problems occur even with the inert gas or hydrogen added plasma, such as an unrestrained film formation, lack of nitrogen and inert gas residue in the film caused by an imperfect bond.

### BRIEF SUMMARY OF THE INVENTION

The present invention is directed, for example, to an improved method that irradiates plasma of a material (a material in the plasma state) to a substrate and introduces the material into the substrate.

A method according to one aspect of the present invention for irradiating plasma of a material to a substrate and introducing the material into the substrate includes an irradiation step of irradiating the plasma to the substrate during an irradiation time period in which the material is not diffused in the substrate, and a non-irradiation step of stopping irradiation of the plasma to the substrate during a non-irradiation time period in which the plasma disappears, wherein the irradiation step and the non-irradiation step are repeated.

Further features of the present invention will become apparent from the following description of exemplary embodiments with reference to the attached drawings.

### BRIEF DESCRIPTION OF THE DRAWINGS

FIG. 1 is a schematic sectional view showing a structure of a processing apparatus used for a plasma processing method according to the present invention.

FIGS. 2A-2C are views for explaining the plasma processing method according to the present invention. FIG. 2A is a view showing an output power application method (i.e., switching between ON and OFF) of a radiofrequency oscillator. FIG. 2B is a view showing plasma density changes with the output power of the radiofrequency oscillator shown in FIG. 2A. FIG. 2C is a view showing wafer's surface temperature changes with the output power of the radiofrequency oscillator shown in FIG. 2A.

FIG. 3 is a graph showing a relationship between a depth from the wafer's surface and a nitrogen concentration when the plasma is continuously emitted into the wafer and when the plasma is intermittently emitted into the wafer.

FIG. 4 is a graph showing the dependency of the ion energy incident upon the wafer for the internal pressure of a vacuum chamber.

FIG. 5 is a graph showing a relationship between a half maximum depth in which nitrogen concentration becomes half in the nitrogen concentration distribution in the depth direction, and a nitriding time period using a diffusion coefficient of 5E-21 m²/s.

FIGS. 6A-6C are views for explaining an conventional plasma processing method disclosed in Japanese Patent Laid-Open No. 2004-296603. FIG. 6A is a view showing an output power application method (i.e., switching between ON and OFF) of a radiofrequency oscillator. FIG. 6B is a view showing plasma density changes with the output power of the radiofrequency oscillator shown in FIG. 6A. FIG. 6C is a view showing wafer's surface temperature changes with the output power of the radiofrequency oscillator shown in FIG. 6A.

### DESCRIPTION OF THE EMBODIMENTS

Referring now to the accompanying drawings, a description will be given of an embodiment of the present invention. In each figure, the same reference numeral designates the same element, and a duplicate description thereof will be omitted.

This inventor has earnestly studied a plasma processing method that solves problems in the conventional silicon-oxide-film nitriding. As a result, this inventor has discovered a repetition of a short-term plasma emission into a substrate surface and a plasma non-emission can restrain a film formation and introduce nitrogen even into a thin silicon oxide film at a high concentration.

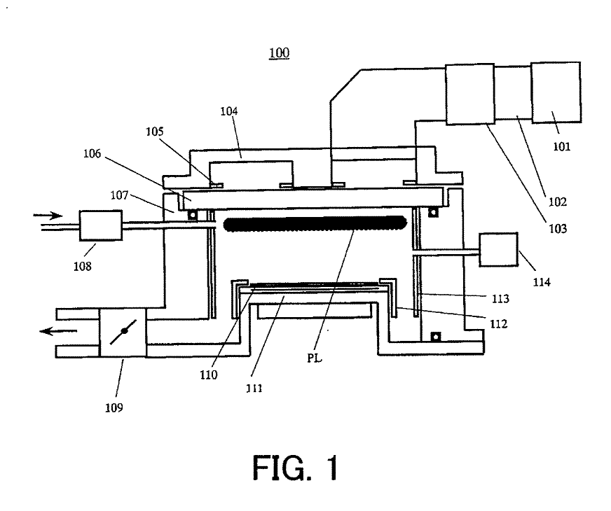

Referring to FIG. 1, a description will be given of a plasma processing method according to one aspect of the present invention. The inventive plasma processing method nitrides a silicon oxide film using the plasma. FIG. 1 is a schematic sectional view showing a structure of a processing apparatus 100 used for the inventive plasma processing method.

The processing apparatus 100 is implemented, for example, as a surface-wave interfered plasma (SIP) processing apparatus. In the processing apparatus 100 shown in FIG. 1, 101 denotes a radiofrequency oscillator, 102 a waveguide, 103 a matching unit, 104 an annular waveguide, 105 a slot antenna, 106 a quartz dielectric material window, 107 a vacuum chamber, 108 a mass flow controller, 109 a variable conductance valve, 110 a (silicon) wafer, 111 a susceptor, 112 a susceptor cover, 113 a vacuum chamber cover, and 114 a pressure sensor (Baratron). The structure of the processing apparatus 100 shown in FIG. 1 is mere illustrative, and can adopt any structure known in the art.

Initially, the vacuum chamber 107 is opened to air, and the wafer 110 is mounted on the susceptor 111 that has a preset temperature. Then, exhausting means (not shown) pumps the vacuum chamber 107 until the internal pressure of the vacuum chamber 107 becomes about 0.1 Pa. A gas is introduced via the mass flow controller 108 to the inside of the exhausted vacuum chamber 107, and the internal pressure of the vacuum chamber 107 is set to the predetermined pressure, by adjusting the variable conductance valve 109 while the pressure sensor 114 measures the pressure.

Next, a microwave of 2.45 GHz is emitted into the inside of the vacuum chamber 107 from the slot antenna 105 arranged under the annular waveguide 104 via the dielectric material window 106, generating a sheet-shaped surface-wave plasma PL on the surface of the dielectric material window 106. The plasma PL generated on the surface of the dielectric material window 106 is transported to the wafer 110 on the susceptor 111 through the ambipolar diffusion. Thereby, the ions as reactive species are accelerated by a sheath formed on the surface of the wafer 110, and incident upon the wafer 110. The vacuum chamber 107 and the susceptor 111 are similarly exposed to the ion impacts, and thus are covered by the quartz vacuum chamber cover 113 and the susceptor cover 112 to prevent metallic contaminations.

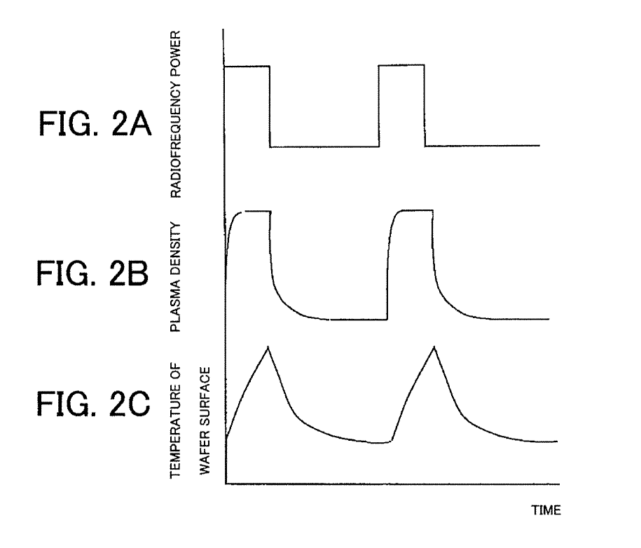

FIGS. 2A to 2C are views for explaining the inventive plasma processing method. FIG. 2A is a view showing an output power application method (i.e., switching between ON and OFF) of the radiofrequency oscillator 101. FIG. 2B is a view showing plasma density changes with the output power of the radiofrequency oscillator 101 shown in FIG. 2A. FIG. 2C is a view showing wafer 110's surface temperature changes with the output power of the radiofrequency oscillator 101 shown in FIG. 2A. As shown in FIG. 2, the inventive plasma processing method intermittently generates the plasma PL by intermittently applying the radiofrequency power, and nitrides the wafer 110 by intermittently emitting the plasma PL to the wafer 110.

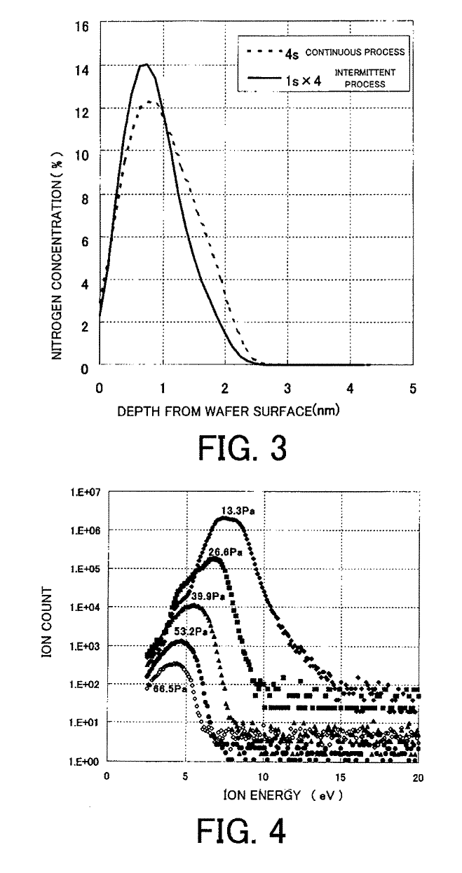

FIG. 3 is a graph showing a relationship between a depth from the wafer 110's surface and a nitrogen concentration when the plasma PL is continuously emitted into the wafer 110 (continuous process) and when the plasma PL is intermittently emitted into the wafer 110 (intermittent process) In FIG. 3, the abscissa axis denotes a depth from the surface of the wafer 110, and the ordinate axis denotes the nitrogen concentration. FIG. 3 shows an analysis result (broken line) of the wafer into which the plasma PL is emitted continuously for 4 seconds, and an analysis result (solid line) of the wafer for which the 1-second plasma PL emission and 10-second plasma PL non-emission are repeated four times. It is understood from FIG. 3 that although the nitrogen dose introduced to the silicon oxide film is approximately the same between the continuously processed wafer and the intermittently processed wafer, nitrogen in the intermittently processed wafer distributes at positions closer to the surface.

A description will now be given of a mechanism of the intermittent process that can introduce nitrogen to the positions closer to the surface of the film or wafer. The microscopic nitriding mechanism of a silicon oxide film has been considered to be a reaction that institutes O with N in Si—O—Si due to N⁺ ions (nitrogen plasma). This is because the nitrogen surface density (area density) introduced to the silicon oxide film is plotted on one line relative to a dose of ions incident upon the wafer, even when a process condition, such as the pressure, is changed. A reduction of the incident ion energy is a sole solution for nitriding at positions near the wafer's surface if such a reaction can explain nitriding of a silicon oxide film.

FIG. 4 is a graph showing the dependency of the ion energy incident upon the wafer relative to the internal pressure in the vacuum chamber. An ion analyzer is used for a measurement necessary to produce the graph shown in FIG. 4. Referring to FIG. 4, as the internal pressure of the vacuum chamber increases, the ion energy distribution shifts to the low energy side and lowers the flux. This result indicates that a high-pressure process may nitride a wafer at the positions close to its surface.

However, actual long-term nitriding of the wafer under a high-pressure condition results in nitriding of deep positions from the wafer's surface. In the plasma nitriding of a silicon oxide film, another factor may exist which determines the nitrided depth in addition to the substitution reaction using N⁺ ions.

A result of the experiment and consideration by this inventor has revealed that a diffusion phenomenon of introduced nitrogen should be addressed. In addition, a value of a diffusion coefficient was about 1E-21 to 1E-20 m²/s although the value slightly changes according to the condition, although a thermal diffusion coefficient of a silicon oxide film in the temperature range used for the actual process is much smaller than this value as described in the prior art document. It is assumed from the fact that the nitrogen profile does not change at all even if it is annealed at 300° C. for a long time that a numerical value obtained by this inventor is a numerical value with a so-called plasma enhanced diffusion phenomenon, which is an accelerated diffusion by the plasma emissions, such as ions and light.

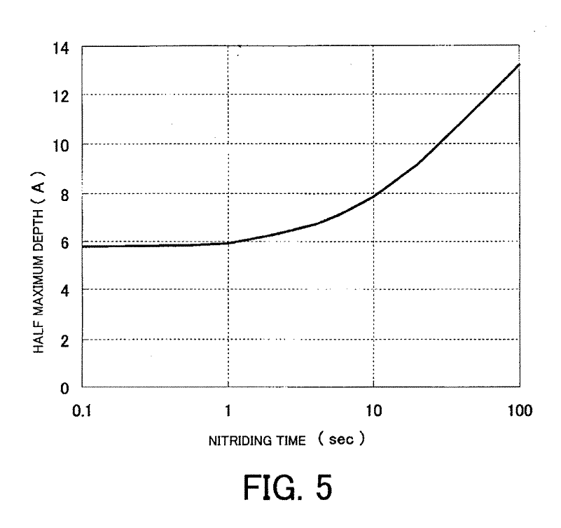

FIG. 5 is a graph showing a relationship between a half maximum depth in which nitrogen concentration becomes half in the nitrogen concentration distribution in the depth direction, and a nitriding time period using a diffusion coefficient of 5E-21 m²/s. Referring to FIG. 5, a spread of the half maximum depth due to the diffusion rapidly increases around an excess of 1 second of nitriding time. Hence, the plasma emission time period (discharge time period) is preferably set to 1 second or shorter, more preferably 0.5 seconds or shorter. Since it takes about 0.2 seconds for the plasma emission intensity to reach the stable range (about 90%), the plasma emission time period (discharge time period) is set to at least 2 seconds or longer.

On the other hand, the plasma non-emission or cessation period is determined by two conditions. The first condition is that the plasma emission completely ends by taking the plasma enhanced diffusion phenomenon, and the second condition is that the plasma-induced wafer's surface temperature sufficiently decreases.

Conventional conferences and documents report an attenuation behavior of the active species in the plasma after the radiofrequency power stops. It is reported that depending upon a type of the active species, for example, ions attenuate within several hundreds microseconds, and neutral particles in the excited state (metastable state) attenuate within several seconds. The metastable state of a nitrogen molecule in the nitrogen plasma has such a very long life as about 1 second.

The wafer's surface temperature rise due to the plasma emission and the soaking or thermal uniformization due to thermal diffusion after the discharge stops can be easily calculated with the silicon's thermal diffusion coefficient. More specifically, a time period necessary to make the wafer's front surface temperature and its back surface temperature equal to each other is about several milliseconds. Although the wafer's temperature rise in the short-term plasma emission is as little as several degree Celsius, the wafer's temperature rise cannot be disregarded when the plasma emission repeats.

Conceivably, as the wafer's temperature rises, the diffusion coefficient becomes larger due to the plasma enhanced diffusion phenomenon, and the wafer's temperature is preferably always maintained as high as the susceptor's temperature. In a vacuum, the heat conduction is small between the wafer and the susceptor, and it takes several seconds for the thermal uniformization.

Thus, 10 milliseconds or longer is preferable for the plasma non-emission time period (discharge stop period) because the ions in the plasma disappear and the wafer's surface temperature and the internal temperature become uniform. 10 seconds or longer is more preferable for the plasma non-emission time period (discharge stop period) because the neutral activated species in the plasma completely disappear and the wafer's surface temperature and the internal temperature become uniform.

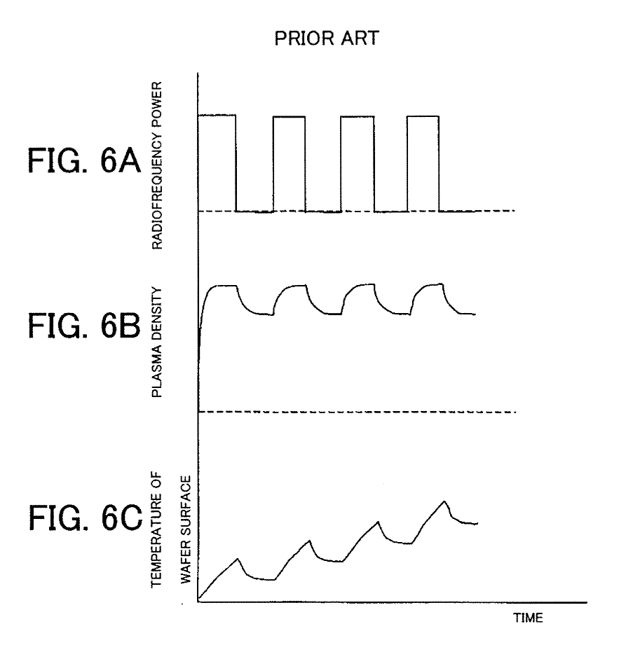

Japanese Patent Laid-Open No. 2004-296603 discloses a processing method that uses the pulse discharge plasma and relates to the inventive plasma processing method that nitrides the wafer by intermittent plasma emissions. However, the inventive plasma processing method is quite different from the processing method disclosed in Japanese Patent Laid-Open No. 2004-296603. FIGS. 6A to 6C are views for explaining the conventional processing method disclosed in Japanese Patent Laid-Open No. 2004-296603. FIG. 6A is a view showing an output power application method (i.e., switching between ON and OFF) of a radiofrequency oscillator. FIG. 6B is a view showing plasma density changes with the output power of the radiofrequency oscillator shown in FIG. 6A. FIG. 6C is a view showing wafer's surface temperature changes with the output power of the radiofrequency oscillator shown in FIG. 6A.

Referring to FIGS. 6A to 6C, the conventional processing method in Japanese Patent Laid-Open No. 2004-296603 applies the next radiofrequency power while ions still sufficiently survive in the plasma after the discharge stops, as stating “the radiofrequency field's pulse modulation time is 5 μsec to 50 μsec inclusive.” In other words, the conventional processing method modulates the plasma density and the electron temperature with respect to time, the plasma always exits. Hence, the plasma density does not become completely zero (see FIG. 6B), and the wafer's temperature gradually rises (see FIG. 6C).

On the other hand, the inventive plasma processing method applies the next radiofrequency power after the plasma and the neutral activated species completely disappear. The inventive plasma processing method can switches on and off the radiofrequency power similar to the conventional processing method, but is different from it in that the generated plasma is intermittent plasma (whereas the generated plasma is the continuous plasma in the conventional processing method). The effect that is derived from the difference is crucial as discussed above.

The inventive plasma processing method has been discussed with nitriding of a silicon oxide film in an example, but the inventive plasma processing method is similarly effective to a plasma doping process that dopes B, P or As in a silicon substrate, and applicable to various surface modification processes, such as surface nitriding of an interlayer dielectric (interlayer insulation film) (such as a carbon inclusive silicon oxide film and a fluorine inclusive silicon oxide film), which needs to restrain an increase of the effective dielectric constant in the Low-k film etc.

A description will now be given of the plasma processing method according to the present invention in more detail.

### First Embodiment

A first embodiment is an illustration in which the inventive plasma processing method is applied to nitriding of a comparatively thick silicon oxide film having a film thickness of 1.8 nm formed through rapid thermal processing (“RTP”). A structure of the processing apparatus is similar to the processing apparatus 100 shown in FIG. 1. The dielectric material window uses quartz having a diameter of 327 mm, and a thickness of 13 mm. The slot antenna has a shape with six slots arranged in a radial direction every 60°.

The silicon substrate is placed on a susceptor whose temperature has been set to 280° C., and the vacuum chamber is pumped through a turbo molecular pump and a dry pump. N₂ gas of 200 sccm is supplied to the vacuum chamber, and the variable conductance valve is adjusted to set the internal pressure to 40 Pa.

Next, a microwave source of 2.45 GHz oscillates a microwave of 1.5 kW, and emits a microwave to the inside of the vacuum chamber via a dielectric material window from a slot antenna under an annular waveguide, generating surface-wave plasma.

For a first wafer (referred to as a “wafer A”), the plasma was continuously discharged for 4 seconds (continuous process). For a second wafer (referred to as a “wafer B”), a 1-second plasma discharge (emission) and 10-second cessation (plasma non-emission) were repeated four times (intermittent process).

As a result of measurements of the surfaces of the wafers A and B using an X-ray photoelectron Spectroscopy (“XPS”), the surface density of nitrogen is almost the same between the wafer A (which has 1.1E15 atoms/cm²) and the wafer B (which has 1.03E15 atoms/cm²). A physical film thickness is 2.05 nm for the wafer A, and 1.9 nm for the wafer B, and the intermittently processed wafer B has a smaller value. This suggests that the continuously processed wafer A suffers a film formation due to a nitrided substrate, whereas the intermittently processed wafer B restrains nitriding of the substrate.

Next, two wafers (nitrided silicon oxide films) are used to produce a MOSFET. According to a comparison result of the characteristic, the continuously processed wafer A has a slightly increased EOT of 1.85 nm, whereas the intermittently processed wafer B has a drastically reduced EOT of 1.6 nm. The leak current downs one place relative to the leak current of the silicon oxide film of each EOT. The mutual conductance (Gm) of nMOSFET is 0.55 ms for the continuously processed wafer A, and 0.6 ms for the intermittently processed wafer B and the intermittently processed wafer B improves by about 10%.

### Second Embodiment

A second embodiment is an illustration in which the inventive plasma processing method is applied to nitriding of an extremely thin silicon oxide film having a film thickness of 1.2 nm formed through RTP. A structure of the processing apparatus is similar to the processing apparatus 100 shown in FIG. 1. The dielectric material window uses quartz having a diameter of 327 mm, and a thickness of 13 mm. The slot antenna has a shape with six slots arranged in a radial direction every 60°.

The silicon substrate is placed on a susceptor whose temperature has been set to 280° C., and the vacuum chamber is pumped through a turbo molecular pump and a dry pump. N₂ gas of 500 sccm is supplied to the vacuum chamber, and the variable conductance valve is adjusted to set the internal pressure to 66 Pa.

Next, a microwave source of 2.45 GHz oscillates a microwave of 1.5 kW, and emits a microwave to the inside of the vacuum chamber via a dielectric material window from a slot antenna under an annular waveguide, generating surface-wave plasma.

For a first wafer (referred to as a “wafer C”), the plasma was continuously discharged for 4 seconds (continuous process). For a second wafer (referred to as a “wafer D”), a 0.5-second plasma discharge (emission) and 10-second cessation (plasma non-emission) were repeated eight times (intermittent process).

As a result of measurements of the surfaces of the wafers C and D using a XPS, the surface density of nitrogen is almost the same between the wafer C (which has 5.5E14 atoms/cm²) and the wafer D (which has 4.9E14 atoms/cm²). A physical film thickness is 1.6 nm for the wafer C, and 1.3 nm for the wafer D, and the intermittently processed wafer D has a smaller value. This suggests that the continuously processed wafer C suffers a film formation through a nitrided substrate, whereas the intermittently processed wafer D restrains nitriding of the substrate.

Next, two wafers (nitrided silicon oxide films) were used to produce a MOSFET. According to a comparison result of the characteristic, the continuously processed wafer C has a slightly increased EOT of 1.45 nm, whereas the intermittently processed wafer D has a reduced EOT of 1.1 nm. The leak current downs one place relative to the leak current of the silicon oxide film of each EOT. The mutual conductance (Gm) of nMOSFET is 0.55 ms for the continuously processed wafer C, and 0.65 ms for the intermittently processed wafer D and the intermittently processed wafer D improves by about 30%.

It is found from the above result that the inventive plasma processing method can obtain a more improved effect in nitriding of an extremely thin film.

### Third Embodiment

A third embodiment is an illustration in which the inventive plasma processing method is applied to nitriding of an extremely thin silicon oxide film (so-called chemical oxide) having a film thickness of 0.9 nm formed through automated precision machining (“APM”) cleansing. A structure of the processing apparatus is similar to the processing apparatus 100 shown in FIG. 1. The dielectric material window uses quartz having a diameter of 327 mm, and a thickness of 13 mm. The slot antenna has a shape with six slots arranged in a radial direction every 60°.

The silicon substrate is placed on a susceptor whose temperature has been set to 280° C., and the vacuum chamber is pumped through a turbo molecular pump and a dry pump. N₂ gas of 500 sccm is supplied to the vacuum chamber, and the variable conductance valve is adjusted to set the internal pressure to 66 Pa.

Next, a microwave source of 2.45 GHz oscillates a microwave of 1.5 kW, and emits a microwave to the inside of the vacuum chamber via a dielectric material window from a slot antenna under an annular waveguide, generating surface-wave plasma.

For a first wafer (referred to as a “wafer E”), the plasma was continuously discharged for 3 seconds (continuous process). For a second wafer (referred to as a “wafer F”), a 0.5-second plasma discharge (emission) and 10-second cessation (plasma non-emission) were repeated six times (intermittent process).

As a result of measurements of the surfaces of the wafers E and F using a XPS, the surface density of nitrogen is almost the same between the wafer E (which has 1.25E15 atoms/cm²) and the wafer F (which has 1.14E15 atoms/cm²). A physical film thickness is 1.6 nm for the wafer E, and 1.2 nm for the wafer F, and the intermittently processed wafer F has a smaller value. This suggests that both the substrates of the wafers E and F are nitrided and suffer a film formation, although the intermittently processed wafer F more effectively restrains nitriding of the substrate.

Next, these two wafers (nitrided silicon oxide films) were used to produce a MOSFET. In producing the MOSFET, the nitrided silicon substrate is oxided by the RTP unit, and then a gate electrode is formed to it. According to a comparison result of the characteristic, the continuously processed wafer E has an EOT of 1.6 nm, whereas the intermittently processed wafer F has an EOT of 1.15 nm. The leak current downs one place relative to the leak current of the silicon oxide film of each EOT. Theutual conductance (Gm) of nMOSFET is 0.55 ms for the continuously processed wafer E, and 0.65 ms for the intermittently processed wafer F and the intermittently processed wafer F improves by about 20%.

It is found from the above result that the inventive plasma processing method can also obtain a more improved effect in nitriding of chemical oxide.

### Fourth Embodiment

A fourth embodiment is an illustration in which the inventive plasma processing method is applied to nitriding of plasma doping of B atoms into a silicon substrate. A structure of the processing apparatus is similar to the processing apparatus 100 shown in FIG. 1. This embodiment uses H₂ gas, and a member that contacts the plasma is made of AlN. More specifically, the dielectric material window uses AlN having a diameter of 327 mm, and a thickness of 13 mm. The slot antenna has a shape with six slots arranged in a radial direction every 60°.

The silicon substrate to which chemical oxide is added through AMP cleansing is placed on a susceptor whose temperature has been set to 280° C., and the vacuum chamber is pumped through a turbo molecular pump and a dry pump so that the internal pressure becomes 0.1 Pa. H₂ gas of 190 sccm and B₂H₆ of 10 sccm are supplied to the vacuum chamber, and the variable conductance valve is adjusted to set the internal pressure to 25 Pa.

Next, a microwave source of 2.45 GHz oscillates a microwave of 1.5 kW, and emits a microwave to the inside of the vacuum chamber via a dielectric material window from a slot antenna under an annular waveguide, generating surface-wave plasma.

For a first wafer (referred to as a “wafer G”), the plasma was continuously discharged for 30 seconds (continuous process). For a second wafer (referred to as a “wafer H”), a 1-second plasma discharge (emission) and 5-second cessation (plasma non-emission) were repeated thirty times (intermittent process). After this process ended, the entry of the process gas stopped, the inside of the vacuum chamber is purged with N₂ gas, and then the wafer was taken out.

As a result of a measurement with a secondary ionization mass spectrometer (“SIMS”) in a depth direction distribution of a boron concentration on a surface of each of the wafers G and H, the surface density of boron is almost the same between the wafer G (which has 2.6E15 atoms/cm²) and the wafer H (which has 2.2E15 atoms/cm²). The half maximum depth was 8.5 nm for the wafer G, and 6.5 nm for the wafer H, and the intermittently processed wafer H has a smaller value.

It was found from the above result that each of the two wafers suffers a B-doped substrate, but the intermittently processed wafer H could introduce B into the substrate at positions closer to the surface.

### Fifth Embodiment

A fifth embodiment is an illustration in which the inventive plasma processing method is applied to nitriding of a surface of a so-called Low-k film or SiOC low-dielectric-constant interlayer dielectric. The Low-k film needs a lamination or formation of a SiN film called an etch stop layer (“ESL”) on a surface to enhance the CMP durability. However, SiN film has a high dielectric constant, and needs to be thinner to reduce the effective dielectric constant of the entire lamination layer. A structure of the processing apparatus is similar to the processing apparatus 100 shown in FIG. 1. The dielectric material window uses quartz having a diameter of 327 mm, and a thickness of 13 mm. The slot antenna has a shape with six slots arranged in a radial direction every 60°.

The silicon substrate having a SiOC film is placed on a susceptor whose temperature has been set to 280° C., and the vacuum chamber is pumped through a turbo molecular pump and a dry pump. N₂ gas of 500 sccm is supplied to the vacuum chamber, and the variable conductance valve is adjusted to set the internal pressure to 66 Pa.

Next, a microwave source of 2.45 GHz oscillates a microwave of 1.5 kW, and emits the microwave inside the vacuum chamber via a dielectric material window from a slot antenna under an annular waveguide, generating the surface-wave plasma.

For a first wafer (referred to as a “wafer I”), the plasma was continuously discharged for 30 seconds (continuous process). For a second wafer (referred to as a “wafer J”), a 1-second plasma discharge (emission) and 5-second cessation (plasma non-emission) were repeated 30 times (intermittent process).

As a result of a measurement with a SIMS in a depth direction distribution of a nitrogen concentration on a surface of each of the wafers I and J, the nitrogen peak concentration is almost the same between the wafer I (which has 48%) and the wafer J (which has 46%). The half maximum depth in which the nitrogen concentration peak becomes half was 7.5 nm for the wafer I, and 5.5 nm for the wafer H, and the intermittently processed wafer H has a smaller value.

It was found from the above result that when the ESL is formed of the surface of the SiOC film by the inventive plasma processing method, the ESL can be thinner than ever, thereby restraining the effective dielectric constant.

Thus, the present invention can provide a plasma processing method that can introduce a material different from a substrate into the substrate surface at a high concentration without thickening the substrate (film formation).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2006-149751, filed on May 30, 2006, which is hereby incorporated by reference herein in its entirety.

What is claimed is:

1. A method for irradiating plasma of a material to a substrate and introducing the material into the substrate, said method comprising:
an irradiation step of irradiating the plasma to the substrate during an irradiation time period in which the material is not diffused in the substrate; and
a non-irradiation step of stopping irradiation of the plasma to the substrate during a non-irradiation time period in which the plasma disappears,
wherein the irradiation step and the non-irradiation step are repeated.

2. A method according to claim 1, wherein the irradiation time period is not shorter than 0.2 seconds and not longer than 1 second.

3. A method according to claim 1, wherein the irradiation time period is not shorter than 0.2 seconds and not longer than 0.5 seconds.

4. A method according to claim 1, wherein the non-irradiation time period is not shorter than 10 milliseconds.

5. A method according to claim 1, wherein the non-irradiation time period is not shorter than 10 seconds.

6. A method according to claim 1, wherein the non-irradiation time period is longer than a time period necessary for ions contained in the plasma to disappear, and longer than a time period necessary for a surface temperature of the substrate and an internal temperature of the substrate to be substantially equal to each other.

7. A method according to claim 1, wherein the non-irradiation time period is longer than a time period necessary for neutral activated species contained in the plasma to disappear, and longer than a time period necessary for a temperature of the substrate and a temperature of a holder for holding the substrate to be substantially equal to each other.

8. A method according to claim 1, wherein the substrate includes a silicon oxide film, and the material includes nitrogen.

9. A method according to claim 1, wherein the substrate includes silicon, and the material includes one of boron, phosphorus, and arsenic.

10. A method according to claim 1, wherein the substrate includes one of a carbon inclusive silicon oxide film and a fluorine inclusive silicon oxide film, and the material includes nitrogen.
